(19) United States
(12) Patent Application Publication
(10) Pub. No.: US 2006/0214944 A1
(43) Pub. Date: Sep. 28, 2006

(54) Display apparatus and control method thereof

(75) Inventor: Ha-hyoung Kim, Seongnam-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/268,636

(22) Filed: Nov. 8, 2005

(30) Foreign Application Priority Data
Mar. 28, 2005 (KR) 10-2005-0025591

(51) Int. Cl. G09G 5/02

(52) U.S. Cl. 345/594

(57) ABSTRACT

A display apparatus including a user input to select a color area control mode and a display part to display an image thereon is provided. The display apparatus further includes a color converter to convert a color distributed in a predetermined color area of colors displayed on the display part in the color area control mode, and a controller to control the image being currently displayed on the display part to be stopped if the color area control mode is selected through the user input, and the color converter to convert the color distributed in the color area in which a selection color is included if the selection color is selected through the user input by designating the stopped images as a standard image. Thus, a display apparatus is provided which changes a color distributed in a color area of a color space based on an image that a user currently watches, to display on a display part.

### CROSS-REFERENCE TO RELATED APPLICATIONS

This application claims priority from Korean Patent Application No. 10-2005-0025591, filed on Mar. 28, 2005, in the Korean Intellectual Property Office, the disclosure of which is incorporated herein by reference in its entirety.

### BACKGROUND OF THE INVENTION

1. Field of the Invention

The present invention relates to a display apparatus and a control method thereof, and more particularly, to a display apparatus which converts colors distributed in a predetermined color area of a color space based on a picture being currently displayed on a display part and a control method thereof.

2. Description of the Related Art

A display apparatus, and particularly, a color display apparatus is widely used in electronic devices which present information in a visual form. Examples of electronic devices that utilize display apparatuses comprise TVs, DTVs (digital TVs), thin film transistor (TFT) LCD monitors or TFT LCD TVs, color printers, digital cameras, projectors, mobile phones, etc.

In a conventional display apparatus, the condition of displayed images is controlled by changing the properties of hue, brightness, saturation, etc. of an image signal supplied to the display apparatus. For example, the color of an image displayed in a display apparatus can be controlled by increasing or decreasing the saturation and/or hue components of a colored portion of the image signal input to the display apparatus.

However, when a user changes the color components and/or saturation of a certain color, the color components and/or saturation of all the colors displayed in the display apparatus are changed. For example, when a user changes the property settings of a color to increase a red component and decrease saturation for only a skin-tone color in an image displayed in the display apparatus, the entire color of the image displayed therein, including the skin-tone color and other colors associated with a background image are affected. That is, in the conventional display apparatus, changing the certain color of the image, such as the skin-tone color, results in unexpected changes to the rest of the image.

The conventional display apparatus changes the color components and/or saturations of certain colors such as the skin-tone color, a sky-blue color, a green color, etc., without affecting the rest of colors to solve the forgoing problems. Such a mode that changes the color components and/or saturation in a certain color area is referred to as a color area control mode or my color control (MCC) mode.

However, the conventional display apparatus displays the image stored in a memory on the display part, and controls the color based on the stored image when a user selects the color area control mode. Accordingly, the conventional display apparatus requires memory capacity for storing the image, and a user may feel monotonous as the color area control mode presents identical images only.

### SUMMARY OF THE INVENTION

Accordingly, it is an aspect of the present invention to provide a display apparatus which changes a color distributed in a color area of a color space based on an image that a user currently watches, to display on a display part.

Additional aspects of the invention will be set forth in part in the description which follows and, in part, will be obvious from the description, or may be learned by practice of the invention.

The foregoing and other aspects of the present invention are achieved by providing a display apparatus comprising a user input to select a color area control mode and a display part to display an image thereon, further comprising a color converter to convert a color distributed in a predetermined color area of colors displayed on the display part in the color area control mode, and a controller to control the image being currently displayed on the display part to be stopped if the color area control mode is selected through the user input, and the color converter to convert the color distributed in the color area in which a selection color is included if the selection color is selected through the user input by designating the stopped images as a standard image.

According to an aspect of the present invention, the display apparatus further comprises a UI generator to generate a user interface through which a user may adjust color information to convert colors distributed in the color area.

According to an aspect of the present invention, the user interface comprises a color controller controlled on a picture to adjust the color information of the colors distributed in at least one of the color areas, and a converted image display window to display the converted image which the display state thereof is changed according to operation of the color controller.

According to an aspect of the present invention, the user interface further comprises a standard image display window to display the standard image.

According to an aspect of the present invention, the display apparatus further comprises a frame buffer, wherein the controller stores the standard image in the frame buffer and copies the stored standard image to display it on the converted image display window as the converted image.

According to an aspect of the present invention, the display apparatus further comprises a memory to store a conversion value of the converted image.

According to an aspect of the present invention, the color area comprises at least one memorial color area defined on the basis of distribution of memorial colors recognized with respect to an object.

The foregoing and other aspects of the present invention are achieved by providing a control method of a display apparatus comprising a user input to select a color area control mode and a display part to display an image thereon, further comprising receiving a selection signal to select the color area control mode, stopping the image displayed on the display part, receiving a signal of a selection color based on the stopped image, and converting a color distributed in a predetermined color area in which the selection color is included, set through the user input.

According to an aspect of the present invention, the control method further comprises displaying a user interface on the display part through which a user may adjust color information of colors distributed in the color area.

According to an aspect of the present invention, the control method further comprises displaying a color controller controlled on a picture to adjust the color information of colors distributed in at least one of the color areas, and a converted image display window on the display part to display a converted image which the display state thereof is changed according to operation of the color controller.

According to an aspect of the present invention, the control method further comprises displaying a standard image display window displaying the stopped image, on the display part.

### BRIEF DESCRIPTION OF THE DRAWINGS

The above and other aspects and advantages of the present invention will become apparent and more readily appreciated from the following description of exemplary embodiments, taken in conjunction with the accompany drawings of which:

FIG. 1 is a control block diagram of a display apparatus according to an exemplary embodiment of the present invention;

FIGS. 2A-2C illustrate a user interface according to an exemplary embodiment of the present invention; and

FIG. 3 is a control block diagram of a color conversion process according to an exemplary embodiment of the present invention.

### DETAILED DESCRIPTION OF EXEMPLARY EMBODIMENTS

Reference will now be made in detail to exemplary embodiments of the present invention, examples of which are illustrated in the accompanying drawings, wherein like reference numerals refer to like elements throughout. The embodiments are described below in order to explain the present invention by referring to the figures.

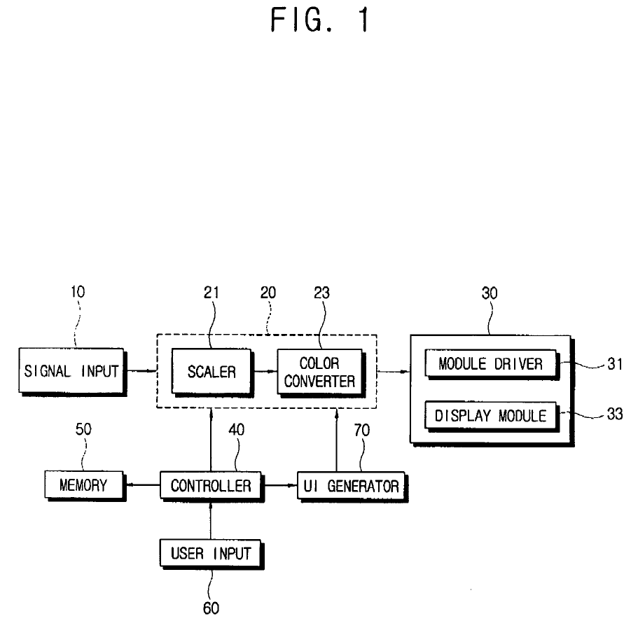

As shown in FIG. 1, a display apparatus according to an exemplary embodiment of the present invention comprises a display part 30 to display an image thereon; a user input 60 to select a color area control mode, a color converter 23 to convert a certain color of the image, and a controller 40 to control the foregoing components. Also, the display apparatus according to an exemplary embodiment of the present invention may comprise a signal input 10 to receive an image signal from an external source, and a signal processor 20 to process the image signal received through the signal input 10 and comprising the color converter 23.

The display part 30 receives the image signal output from the signal processor 20 to display a picture thereon. The display part 30 comprises a display module 33 to display the picture, and a module driver 31 to process the image signal input from the signal processor 20 and make the picture be displayed on the display module 33. The display module 33 according to an exemplary embodiment of the present invention may be provided as various types of display modules such as a cathode ray tube (CRT), a digital light processing (DLP), a liquid crystal display (LCD), a plasma display panel (PDP), etc. Here, if the display module 33 is provided as a DLP, the module driver 31 comprises an optical engine. If the display module 33 is provided as an LCD, the module driver 31 comprises a printed circuit board (PCB) to convert the image signal input from the signal processor 20 into a data signal and a gate signal. That is, the display part 30 may comprise different components, for example, a different module driver 31, corresponding to the type of the display module 33.

The signal input 10 receives the image signal to output the received image signal to the signal processor 20. Also, the signal input 10 may be provided as various components corresponding to the type of the display module 33. For example, if the signal processor 20 according to an exemplary embodiment of the present invention processes a digital image signal, the signal input 10 may comprise an A/D (analog-to-digital) converter to convert an analog image signal into the digital image signal, and extra components to support a low voltage differential signaling (LVDS) or a transition minimized differential signaling (TMDS) interface to support input of the digital image signal. Also, if the display apparatus according to an exemplary embodiment of the present invention receives a TV broadcasting signal, the signal input 10 may comprise a tuner.

The signal processor 20 converts the image signal input through the signal input 10 into an image signal displayable by the display part 30. The signal processor 20 according to an exemplary embodiment of the present invention may comprise various components corresponding to the type of the foregoing display module 33. For example, if the display module 33 according to an exemplary embodiment of the present invention is provided as an LCD, PDP or DLP, the signal processor 20 may comprise a scaler 21 to scale the digital image signal. If the display module 33 according to an exemplary embodiment of the present invention is provided as a CRT, the signal processor 20 may comprise an amplifier (not shown) to amplify the image signal input through the signal input 10, and vertical and horizontal deflectors (not shown) to deflect an electron beam based on vertical and horizontal synchronous signals. Also, the signal processor 20 may further comprise a frame buffer to temporarily store the image signal input from the signal input 10 and then output it to the scaler 21.

Meanwhile, the signal processor 20 may comprise a color converter 23. Here, the color converter 23 converts the image signal output from the scaler 21 to make colors distributed in at least one color area defined by grouping a plurality of colors in a color space among colors displayed on the display part 30, be converted in the color area. For example, if a user selects a blue color as a selection color that a user wants to adjust, colors of the color area with the saturation of a blue color are controlled, and other colors such as a green color, a skin-tone color, etc. may be not affected.

The color converter 23 may be provided as an image enhancement chip or a predetermined chip, and disposed in the scaler 21.

Here, to logically describe color, the color space refers to all colors represented in a three-dimensional coordinate system. The YCbCr color space may be an example of the color space. Also, the CIELAB (L*a*b*) or CIELCH (L*c*h*) color space disclosed by Commission International de Eclairage (CIE) may be used as the color space. Alternatively, other color spaces may be used without departing from the principles and spirit of the present invention.

The color space according to an exemplary embodiment of the present invention uses six axes formed by six basic colors: R (red), Y (yellow), G (green), C (cyan), B (blue), and M (magenta).

The color area is defined by grouping a plurality of colors distributed in the color space. Here, the color converter 23 may recognize the color area by calculating them using a geometric equation in the xyz coordinate system. For example, if the color area is elliptically shaped in the xyz coordinate system, the color converter 23 may recognize the color area by calculating it using an elliptical equation.

Also, the color area may comprise a memorial color area defined on the basis of distribution of a memorial color which is recognized with respect to an object. Here, the memorial color refers to a color of a certain object that a user is familiar with in his/her memory. In an exemplary embodiment of the present invention, it is understood that while a skin-tone color, a sky-blue color and a grass/tree-green color are exemplified, the present invention may be applied with respect to other memorial color areas. Generally, the distribution of the memorial color is shaped like an ellipse in the color space by the relationship between brightness, hue, and saturation. The respective color areas may be defined based on the distribution of the memorial color with respect to the skin-tone color, the sky-blue color and the grass/tree-green color.

Meanwhile, the display apparatus according to an exemplary embodiment of the present invention may further comprise an UI generator 70 to provide a user interface for converting the colors distributed in the color area.

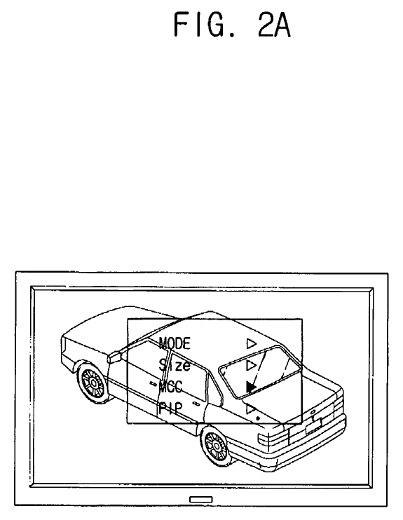

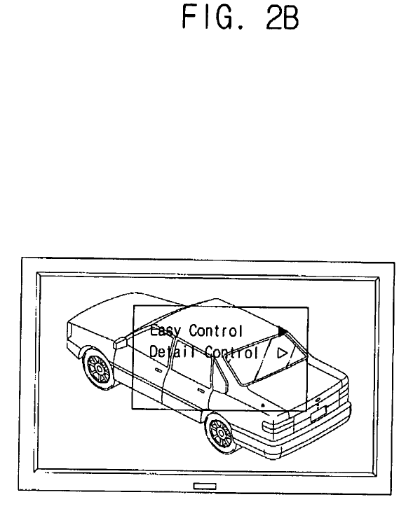

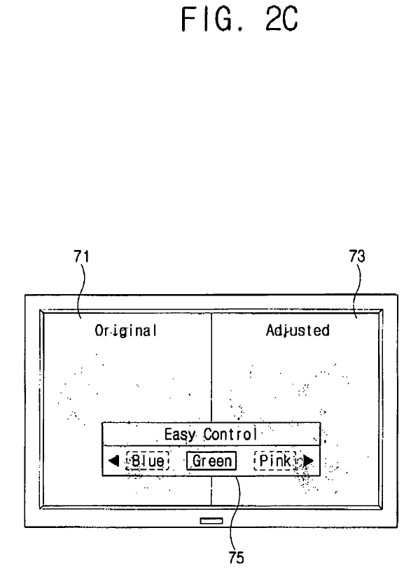

The user interface according to an exemplary embodiment of the present invention comprises a color controller 75 to be controlled on the screen and a converted image display window 73 to display a converted image (refer to FIG. 2C). By controlling the color controller 75, a user converts the colors distributed in the color area. Here, if the color controller 75 is controlled by a user, the color conversion coordinate value of the foregoing standard color is changed. Also, the display condition of the converted image displayed on the converted image display window 73 is changed corresponding to an operation of the color controller 75.

The controller 40 controls the signal processor 20, the signal input 10 and other parts. The controller 40 according to an exemplary embodiment of the present invention controls the color converter 23 to convert the image signal output from the scaler 21 based on a key signal input through a user input 60 (to be described later).

If the color area control mode is selected through the user input 60, the controller 40 controls to stop the picture that a user is currently watching, and controls the color of the picture based on the stopped picture through the user input 60.

Specifically, if the controller 40 determines that the color area control mode is selected, the display part 30 goes into a video mute on state. At this time, the display part 30 is displayed with a black color. Also, the controller 40 may control the image displayed on the display module 33 in the video mute on state to be displayed as a first picture (standard image display window 71) and a second picture (converted image display window 73), for example, a picture out picture (POP). That is, the controller 40 may stop the picture that a user is currently watching to set the picture as the standard image display window 71. Then, the controller 40 reads the standard image through the frame buffer (not shown), and copies the image read through the frame buffer in another window to set it as the converted image display window 73. The controller 40 may unlock the video mute “on” state and make the standard image display window 71 and the converted image display window 73 be displayed on the display part 30.

The controller 40 controls the color converter 23 to control color information of the colors included in the color area of the selection color if a predetermined selection color that a user wants to adjust is selected through the user input 60, and the color information of the selection color is controlled.

Here, the display apparatus according to an exemplary embodiment of the present invention may further comprise the user input 60 which applies the key signal for converting the colors distributed in the color area corresponding to the operation of the color controller 75, to the controller 40. The user input 60 may comprise an OSD control button provided on a front of the display apparatus, an input device such as a keyboard, a mouse of a computer connected with the display apparatus, or a remote controller.

FIGS. 2A-2C illustrate user interfaces according to exemplary embodiments of the present invention. FIG. 2A exemplifies an MCC mode as the color area control mode according to an exemplary embodiment of the present invention.

As shown in FIG. 2A, a user may select the MCC mode through a menu OSD. Alternatively, a user may select the MCC mode through a hot key, etc. If a user selects the MCC mode on a menu as shown in FIG. 2A, the display apparatus according to an exemplary embodiment of the present invention may provide a user interface to go into an easy control mode and a detail control mode. Here, the easy control mode converts colors of the image displayed on the display part 30 easily by a user, and the detail control mode converts the colors of the image in more detail.

The MCC mode may be activated if the MCC mode of FIG. 2A is selected, and may be activated if the easy control mode or the detail control mode of FIG. 2B is selected.

If the display apparatus according to the present invention goes into the MCC mode, the standard image display window 71, the converted image display window 73 and the color controller 75 may be displayed on the display part 30. In an exemplary embodiment of the present invention, the standard image display window 71 and the converted image display window 73 are displayed on the display part 30. Alternatively, the converted image display window 73 may be displayed alone on the display part 30. If the MCC mode is activated, the image displayed on the display part 30 is displayed on the standard image display window 71, and the image identical to the image displayed on the standard image display window 71 is displayed on the converted image display window 73. According to a selection of a user, the image displayed on the converted image display window 73 is converted.

At the operation from FIG. 2A or 2B to FIG. 2A, if determining that the MCC mode is activated, the controller 40 sets the video mute “on” state and prevents the display part 30 from displaying the image. Also, the controller 40 may set the standard image display window 71 and the converted image display window 73, as well as stop the picture. The controller 40 reads standard image data stored in the frame buffer, and copies it to display on the converted image display window 73. The controller 40 unlocks the video mute “on” state and makes the image be displayed on the display part 30 again. Then, the display part 30 displays the standard image display window 71 and the converted image display window 73. Here, the time of the video mute “on” state may be 200 msec as an example. As the screen of the display part 30 is dark for predetermined a time of the video mute “on” state, an unstable picture may not be recognized by a user.

After the foregoing process, if a picture shown in FIG. 2C is displayed on the display part 30, a user selects a certain color as the selection color through the color controller 75 to convert a color in a predetermined color area based on the selection color.

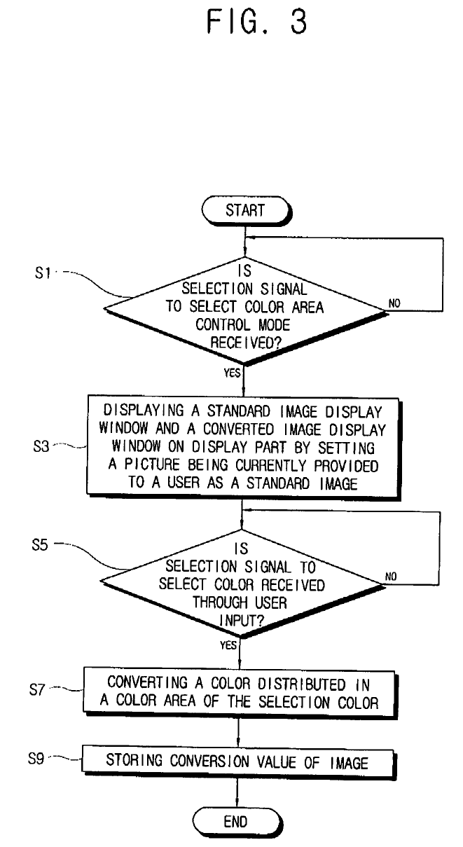

As shown in FIG. 3, in the display apparatus according to an exemplary embodiment of the present invention, the controller 40 stops the picture being currently displayed on the display part 30 if a selection signal that the color area control mode is selected through the user input 60 is received at operation S1. At this time, the controller 40 makes the display part 30 be displayed with a predetermined user interface. The user interface may comprise the color controller 75 controlled on the picture to convert the colors distributed in at least one of the color areas, the converted image display window 73 to display the image converted with the display state according to operation of the color controller 75, and the standard image display window 71 to display the standard image which stops the picture being currently provided to a user, at operation S3.

If the selection color which a user wants is selected through the user input 60 at operation S5 and is controlled, the controller 40 controls the color converter 23 to convert the colors distributed in the predetermined color area according to the selection color at operation S7. The controller 40 stores the converted value in the memory 50 at operation S9. Then, the controller 40 makes the image be displayed on the display part 30 according to the converted image.

In the foregoing exemplary embodiment, the conversion in color in the predetermined color area is performed by the color converter 23. Alternatively, the conversion may be performed by the scaler 21.

As described above, the display apparatus according to exemplary embodiments of the present invention is not required to store the image in an extra memory, thereby reducing predetermined memory capacity. That is, the display apparatus according to exemplary embodiments of the present invention needs not to store the image in a non-volatile memory, thereby saving the capacity of the non-volatile memory, for example, an electrically erasable programmable read-only memory (EEPROM), a flash memory, etc. Also, as a user may convert the color while watching TV based on the image being currently displayed, the color may be converted to be closer to the desired color. Further, it may prevent a user from feeling monotonous due to the identical image displayed in every color conversion.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising a user input to select a color area control mode and a display part to display an image thereon, the display apparatus further comprising:
a color converter which converts a color distributed in a predetermined color area of colors displayed on the display part in the color area control mode; and
a controller which controls the image being currently displayed on the display part to be stopped if the color area control mode is selected through the user input, and the color converter converts the color distributed in the predetermined color area in which a selection color is included if the selection color is selected through the user input by designating the stopped images as a standard image.

2. The display apparatus according to claim 1, further comprising a user interface (UI) generator which generates a user interface through which a user may adjust color information to convert colors distributed in the predetermined color area.

3. The display apparatus according to claim 2, wherein the user interface comprises a color controller controlled on a picture which adjusts the color information of the colors distributed in at least one color area, and a converted image display window which displays a converted image which a display state thereof is changed according to an operation of the color controller.

4. The display apparatus according to claim 3, wherein the user interface further comprises a standard image display window which displays the standard image.

5. The display apparatus according to claim 4, further comprising a frame buffer, wherein the controller stores the standard image in the frame buffer and copies the stored standard image to display on the converted image display window as the converted image.

6. The display apparatus according to claim 1, further comprising a memory to store a conversion value of the converted image.

7. The display apparatus according to claim 1, wherein the predetermined color area comprises at least one memorial color area defined on the basis of distribution of memorial colors recognized with respect to an object.

8. A control method of a display apparatus comprising a user input which selects a color area control mode and a display part which displays an image thereon, the method comprising:
receiving a selection signal to select the color area control mode;
stopping the image displayed on the display part;
receiving a signal of a selection color based on the stopped image; and
converting a color distributed in a predetermined color area in which the selection color is included, the selection color being set through the user input.

9. The control method of the display apparatus according to claim 8, further comprising displaying a user interface on the display part through which a user may adjust color information of colors distributed in the predetermined color area.

10. The control method of the display apparatus according to claim 9, further comprising displaying a color controller controlled on a picture which adjusts the color information of colors distributed in at least one color area, and displaying a converted image display window on the display part to display a converted image which a display state thereof is changed according to an operation of the color controller.

11. The control method of the display apparatus according to claim 8, further comprising displaying a standard image display window displaying the stopped image on the display part.
